(19) United States
(12) Patent Application Publication
(10) Pub. No.: US 2026/0366912 A1
(43) Pub. Date: Nov. 19, 2026

(54) CHANGE POINT DETECTION BASED ON MINIMUM KERNEL-BASED CODING LENGTH

(71) Applicant: NEC Laboratories America, Inc., Princeton, NJ (US)

(72) Inventors: Shaobo HAN, Princeton, NJ (US); Ming-Fang HUANG, Princeton, NJ (US)

(73) Assignee: NEC Laboratories America, Inc., Princeton, NJ (US)

(21) Appl. No.: 19/211,046

(22) Filed: May 16, 2025

(51) Int. Cl. G01H 9/00

(52) U.S. Cl. CPC G01H 9/004

(57) ABSTRACT

Disclosed are distributed fiber optic sensing/distributed acoustic sensing (DFOS/DAS) systems, methods, and structures that advantageously employ minimum coding length as an objective criterion for both change detection and change localization based on a spatial leakage phenomenon in coded-mode DAS. Our change point detection technique is based on global information rather than relying on the change of local statistics. As a result, our inventive systems and methods are robust to outliers. An optimal codebook adapts to individual routes, sensor types, and time periods. Adaption decision-making is performed by comparing coding length under a no-change hypothesis with another under a one-change hypothesis—thereby eliminating the need for a manual threshold. A correlation kernel to capture nonlinear relationships between different locations by comparing similarities. The correlation kernel is scale-free and self-normalizing, which advantageously allows it to handle the location heterogeneity of DFOS signal magnitudes.

### FIELD OF THE INVENTION

This application relates generally to distributed fiber optic sensing (DFOS) systems, methods, and structures. More particularly, it pertains to improved DFOS systems, methods, and structures employing change point detection based on minimum kernel-based coding length.

### BACKGROUND OF THE INVENTION

Distributed Fiber Optic Sensing (DFOS) systems, and methods employ optical fiber as a sensing medium to measure various environmental phenomena including temperature, vibration, mechanical strain and acoustic sounds. Distributed Acoustic Sensing (DAS), utilizes Rayleigh backscattering of optical signals for acoustic and vibration detection. However, commercial DAS systems are constrained by a somewhat limiting 50-km sensing range due to issues resulting from optical signal generation in pulse mode. Contemporary DAS systems have attempted to overcome such defects by employing a coded-mode signal generation technique, i.e., coded-DAS, Notably, coded-DAS exhibits sensitivity to changes in the state of polarization (SOP), however rapid SOP alterations over short durations may distort the optical signal, impacting detection accuracy along the entire length of the optical fiber from a point of distortion onward.

### SUMMARY OF THE INVENTION

An advance in the art is made according to aspects of the present disclosure directed to integrated DFOS/DAS systems, methods, and structures that advantageously—and in sharp contrast to the prior art employ minimum coding length as an objective criterion for both change detection and change localization based on a spatial leakage phenomenon in Coded-mode DAS.

As those skilled in the art will understand and appreciate, our inventive change point detection technique according to aspects of the present disclosure is based on global information rather than relying on the change of local statistics. As a result, our inventive systems and methods are robust to outliers.

Advantageously, an optimal codebook adapts to individual routes, sensor types, and time periods. Adaption decision-making is performed by comparing coding length under a no-change hypothesis with another under a one-change hypothesis—thereby eliminating the need for a manual threshold.

As will become apparent from this disclosure, a phase distortion point is automatically selected from a great number of candidate locations by determining a the point having a minimum coding length.

More particularly, our inventive systems and methods use a correlation kernel to capture nonlinear relationships between different locations by comparing similarities. The correlation kernel is scale-free and self-normalizing, which advantageously allows it to handle the location heterogeneity of DFOS signal magnitudes.

We use kernel PCA to project higher-dimensional feature space implicitly defined by a kernel function to a lower-dimensional space, which preserves pairwise similarities between all locations. The projection is nonlinear, which expands overall features space, and contracts clusters before and after a change point. As a result, our inventive technique makes the exact location of the phase distortion point upon subtle changes easier to find.

As we shall disclose, our inventive systems and methods enable the following applications for coded-mode DAS namely, device-free fiber identification method over long distances; critical warning of cable touching for cable cut prevention; and quick testing of the system after installation of a new route.

Rapid SOP changes within short timeframes on coded-DAS leads to the generation of noise signals extending from the phase distortion point to the end of the fiber (spatial leakage). Based on this observation, we frame the problem of signal detection and location identification into a multivariate change point detection (CPD) problem, with maximally one change point. In particular, we propose an algorithm based on minimizing an information-theoretic metric in kernel-extracted feature space. The specially designed kernel has desired properties such as self-normalizing across the observation time period at each location. This choice prevents false alarms from conventional CPD methods, which can be “misled” by locations in which the variance is high merely because of the floor noise level at that location is high (such as CO, bridge or aerial cable region). The metric is based on minimum description length (MDL) and lossy data compression, which solves both the detection and localization problems simultaneously under a unified framework. Our method is agnostic to the exact pattern of swift SOP changes

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing illustrative change point detection problem in DFOS data according to aspects of the present disclosure.

FIG. 3 shows a series of plots of original DFOS measurements vs pairwise correlations (with change) according to aspects of the present disclosure.

FIG. 4 shows a series of plots of original DFOS measurements vs pairwise correlations (without change) according to aspects of the present disclosure.

FIG. 5 is a flow diagram of our inventive method for change detection and localization according to aspects of the present disclosure.

FIG. 6 shows illustrative expansion and contraction of kernel-extracted features space and impact on coding length under a “no change” hypothesis and “one change” hypothesis according to aspects of the present invention.

FIG. 7 shows change detection performance upon subtle change or no change for our inventive method by a sliding window-based baseline approach according to aspects of the present disclosure.

FIG. 8(A) shows change localization with Zoom-in comparison at around 30 KM and FIG. 8(B) is a plot of ground truth location from zoom-in view of measured DFOS signals according to aspects of the present disclosure.

FIG. 9(A) shows change localization with Zoom-in comparison at around 54 KM and FIG. 9(B) is a plot of ground truth location from zoom-in view of measured DFOS signals according to aspects of the present disclosure.

FIG. 10 is a schematic block diagram of an illustrative computer system in which aspects of the present disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

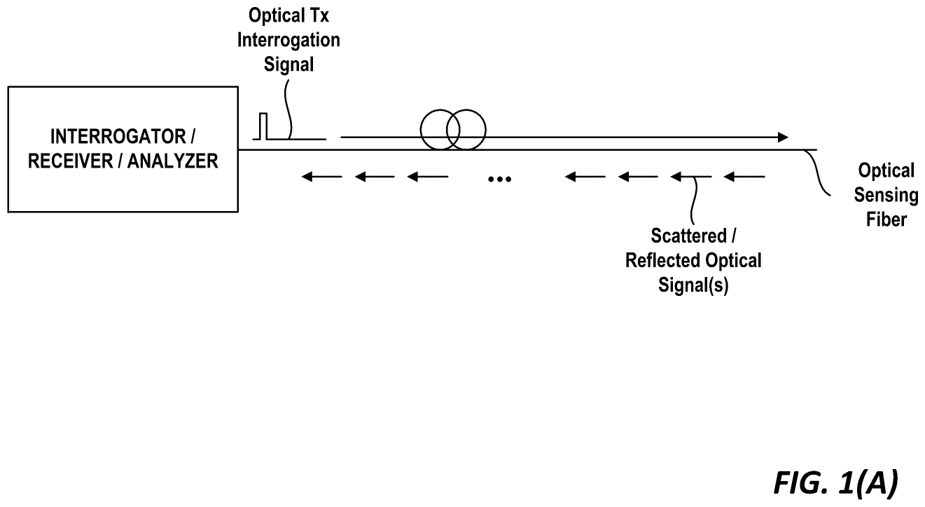

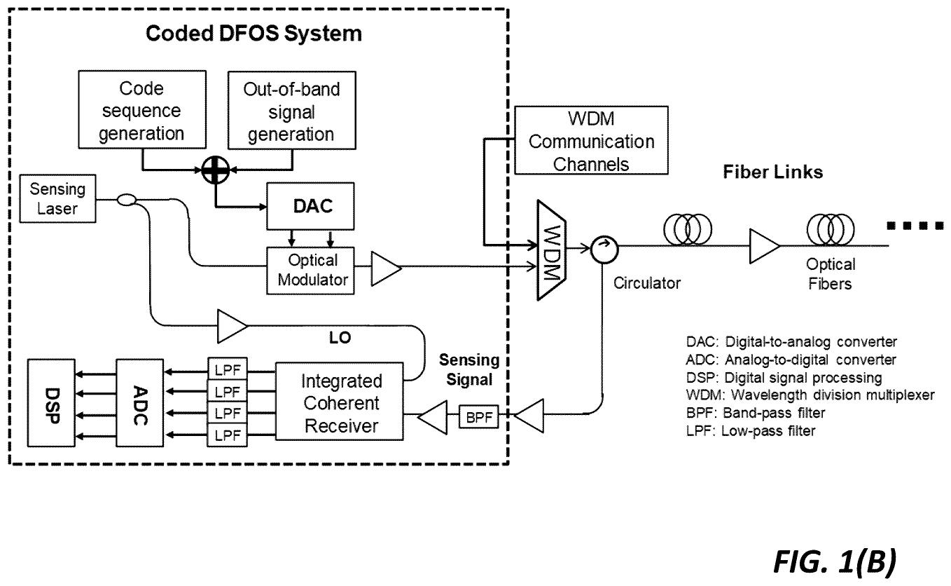

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detect/analyze reflected/backscattered and subsequently received signal(s). The signals received are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As is known, acoustic signals are produced by numerous events, enabling humans to naturally learn various types of sounds through acoustic sensory experiences. Therefore, acoustic signals are one of the essential factors for real-time awareness of surrounding events, as well as image and video data.

For example, the detection of an explosion sound by our ears can immediately indicate an anomaly. Deploying numerous audio sensors, like electric microphones, over large areas can provide valuable acoustic information for anomaly detection and scene or event recognition. However, this approach is energy-intensive, and these devices may require batteries to operate.

One solution to this issue is to use a distributed fiber-optic sensor. This DFOS technology advantageously converts an optical fiber extending over 10 kilometers into a distributed sensor with a spatial resolution on the order of 1 meter. Specifically—as noted above—a sensor employing phase-sensitive optical time-domain reflectometry (Phase-sensitive OTDR), also known as a Distributed Acoustic Sensor (DAS), can convert mechanical dynamic strains on the fiber, caused by acoustic signals, into phase changes in Rayleigh backscattered light. Consequently, this allows for the monitoring of local acoustic events over very large geographic areas using the optical fiber. Of further advantage, the optical fiber may be a telecommunications-carrying optical fiber, thereby allowing telecommunications traffic and DFOS—simultaneously.

Distributed Fiber Optic Sensing (DFOS) technology leverages the existing fiber infrastructures as a potential sensing media, enabling a wide-range, real-time, and continuous monitoring of surrounding environment perception without the need to introduce additional sensing devices. DFOS has been successfully employed in diverse applications including road traffic monitoring, intrusion detection, earthquake detection, pipeline leakage monitoring and structure change detection.

Operational telecommunications optical fiber cable networks hold substantial potential for environmental perception and sensing applications. DFOS technology transforms existing communication cables into individual sensors distributed at every meter along the optical fiber cable, with all the measurements being synchronized. As a result, this sensing technology can be employed to detect events related to both infrastructure itself and its surrounding environments.

As previously noted, a basic principle behind the DFOS is that optical fiber cable conditions such as a change of strain or temperature on the optical fiber cable can influence the properties of the light signal traveling through an optical fiber. When pulsed light is launched into an optical fiber sensing cable, a small fraction of light is backscattered, and its properties are influenced by the fiber cable condition. The backscattered light includes three types of scattering: Raman scattering, Brillouin scattering, and Rayleigh scattering. This methodology gauges alterations in Rayleigh scattering intensity via interferometric phase beating. With coherent detection, the DFOS system retrieves comprehensive polarization and phase information from the backscattering signals, enabling impressive meter-level fiber cable sensor resolution.

In existing fiber optic networks, rapid SOP alternation at one location can be caused by optical cable threats from unauthorized construction or tree branches hanging on the optical cable, or disturbances created for location confirmation of the scheduled maintenance. For example, field technicians could create disturbances by shaking an optical cable to determine whether the cable is one in need of repair, and if so, exactly which location along the length of the cable to repair. This requires reliable feedback from fiber optic smart sensing (FOSS).

We note that as used herein, a fiber optic cable is a network cable that contains thin strands of glass or plastic fibers encased in an insulated covering. These cables are designed for high-performance data networking and telecommunications, enabling long-distance data transmission at high speeds. As those skilled in the art will understand and appreciate, one or more of the optical fibers that may be included in the fiber optic cable are employed for DFOS and used as a sensor fiber in such applications.

We note that to build software systems for FOSS applications, it is useful to have an algorithmic solution to (1) determine whether or not a rapid SOP alternation has occurred along the fiber route, and (2) accurately identify its location across the entire routes among over 20,000 candidate locations. However, (1) the environmental vibration fluctuates wildly along the cable route in time, (2) the shaking patterns varies from different technicians, locations, and sensor types, and (3) swift SOP changes within short timeframes on coded-DAS can unavoidably impact multiple cable locations after the phase distortion points. Because of these three challenges, accurately detecting the change point and precisely identifying its location pose significant difficulties.

As those skilled in the art will understand and appreciate, rapid SOP changes within short timeframes on coded-DAS generally leads to the generation of noise signals extending from the phase distortion point to the end of the fiber (spatial leakage). Based on this observation, we frame the problem of signal detection and location identification into a multivariate change point detection (CPD) problem, with maximally one change point.

We describe an algorithm based on minimizing an information-theoretic metric in kernel-extracted feature space. The specially designed kernel has desired properties such as self-normalizing across the observation time period at each location. This choice prevents false alarms from conventional CPD methods, which can be “misled” by locations in which the variance is high merely because of the floor noise level at that location is high (such as CO, bridge or aerial cable region). The metric is based on minimum description length (MDL) and lossy data compression, which solves both the detection and localization problems simultaneously under a unified framework. Our method is agnostic to the exact pattern of swift SOP changes.

We employ minimum coding length as an objective criteria for both change detection and change localization based on the spatial leakage phenomenon in Coded-mode DAS. Our inventive change point detection method is advantageously based on global information rather than relying on the change of local statistics. Thus, our method is robust to outliers.

Additionally, the optimal codebook adapts to individual routes, sensor types, and time periods. The decision is made by comparing the coding length under the no-change hypothesis with that under the one-change hypothesis, eliminating the need for a manual threshold. The phase distortion point is automatically selected from over a great number of candidate locations through a search for the point with the minimum coding length. In particular,
A) We use correlation kernels to capture nonlinear relationships between different locations by comparing similarities. The kernel is scale-free and self-normalizing, which makes it suitable to handle the location heterogeneity of DFOS signal magnitudes.
B) We use kernel PCA to project higher-dimensional feature space implicitly defined by a kernel function to a lower-dimensional space, which preserves pairwise similarities between all the locations. The projection is nonlinear, which expand the overall features space, and contract the clusters before and after the change point. As a result, it makes the exact location of the phase distortion point upon subtle changes easier to find.

As will become apparent to those skilled in the art, from an application perspective our inventive method enables the following use cases for coded-mode DAS namely, device-free fiber identification method over long distances; critical warning of cable touching for cable cut prevention; and quick testing of the system after installation to a new route

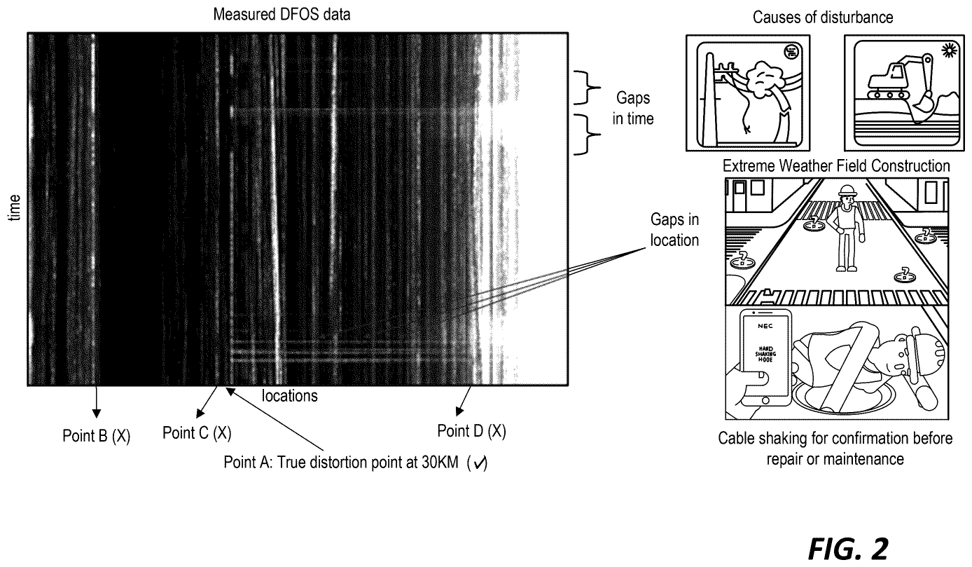

FIG. 2 is a schematic diagram showing illustrative change point detection problem in DFOS data according to aspects of the present disclosure. With reference now to that figure, it may be observed in a left panel of that figure observed data from DFOS measurements. True distortion happens around 30 KM (point A), and it causes the generation of horizontal stripe signals extending from the phase distortion point to the end of the fiber. Among the 24522 candidate locations of the cable route, there are multiple other “noisy”, “anomaly” or “fluctuation” locations look similar to the phase distortion point (points B, C, D), but they are not. Moreover, there are multiple discontinuous points (gaps in location) in the horizontal stripe, which makes the detection of the first change point challenging. In addition, “gaps in time” also exist in the patterns, which is caused by intermittent disturbances.

In the right panel of FIG. 2, it shows some possible reasons for the distortion that causes rapid SOP alternation, such as (1) tree fall due to strong winds or lightning strikes during thunderstorms, (2) unauthorized construction near the deployed cable, and (3) hand shaking signals from technician using detection results from FOSS as a confirmation, before repair or maintenance. In all these scenarios, it is of interest to detect and pinpoint the distortion point rapidly and accurately.

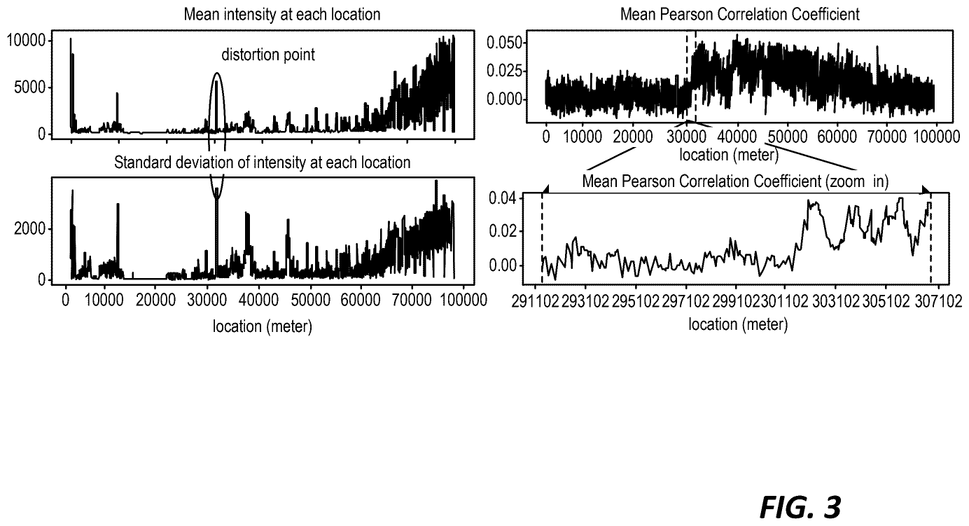

FIG. 3 shows a series of plots of original DFOS measurements vs pairwise correlations (with change) according to aspects of the present disclosure.

In the left panel of FIG. 3, there is shown mean and standard deviation of DFOS measurement at each location, computed from a period of about one minute. There exist multiple peaks. From the figure, it is hard to determine which peak is the distortion point. Therefore, change point detection methods based on local statistics are not applicable to this problem.

In the right panel of FIG. 3, there is shown the average Pearson correlation coefficient at each location, and a zoom-in view of the series near the ground truth distortion point. Although some changes of fluctuation patterns can be now seen from the upper-right figure, it is unclear to say which location is the change point. Failing to precisely pinpoint the distortion point can result in misidentifying locations by several hundreds of meters in practice.

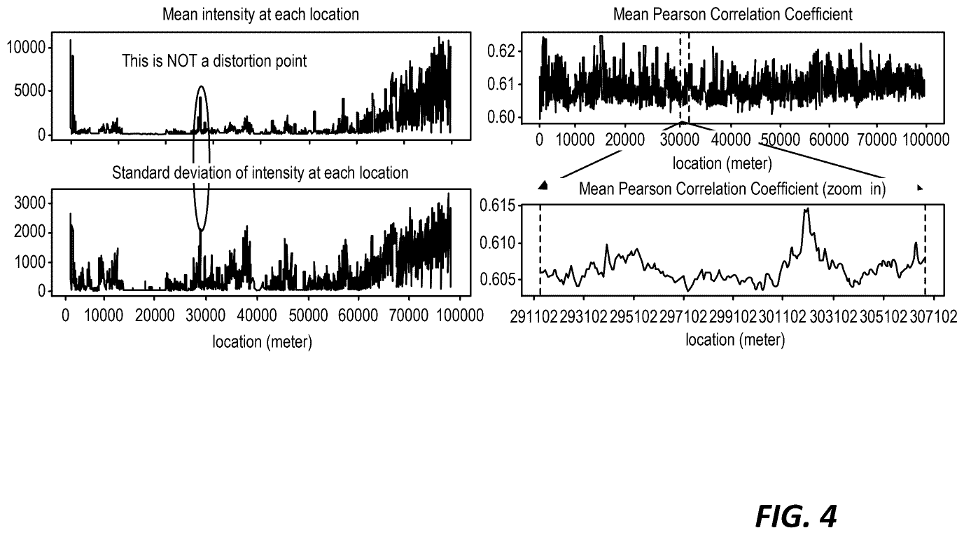

FIG. 4 shows a series of plots of original DFOS measurements vs pairwise correlations (without change) according to aspects of the present disclosure. With reference to that figure, it shows the mean and standard deviation of DFOS measurement, and average Pearson correlation coefficient at each location without change. Although some peaks can be seen from the left panel, they are not distortion points that can cause rapid SOP alternation. Based on the information in the right panel, it's challenging to confirm whether a change has occurred.

In this disclosure, we describe an algorithmic solution to automatic change detection in a quantitative manner.

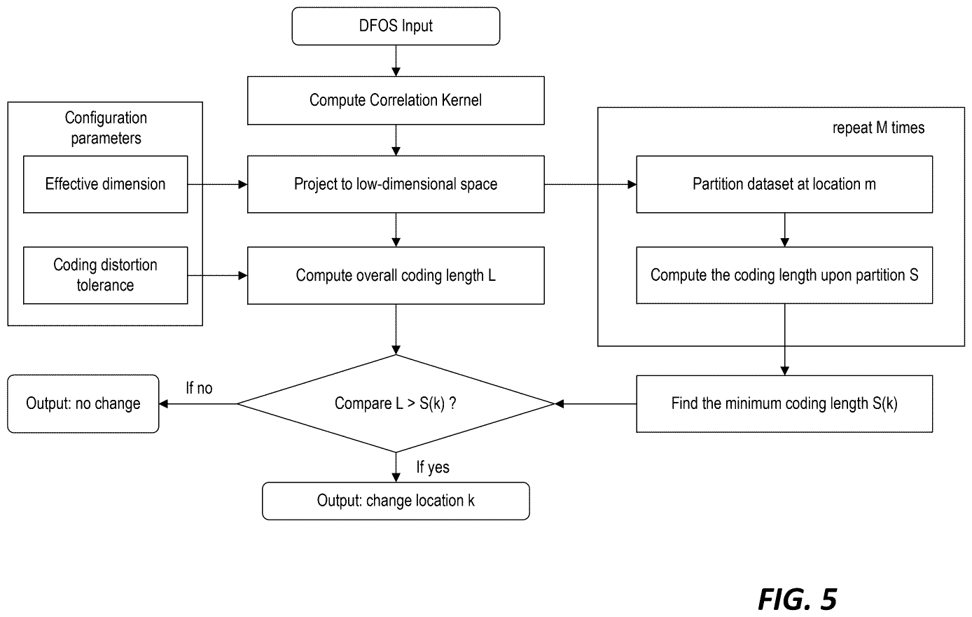

FIG. 5 is a flow diagram of our inventive method for change detection and localization according to aspects of the present disclosure.

To more completely understand our inventive method according to aspects of the present disclosure, we describe a step-by-step description of aspects which generally operate as follows. We denote T observations collected from M locations along a fiber optic cable route as {x_{t,i}}_{t=1:T,i=1:M}, T<M, wherein our goal is to determine whether a change point occurred along the cable route. For fiber identification purpose, we assume there are maximally one change point. If one occurred, reporting the distortion location l among the M candidate locations. The algorithm includes three steps.

### Step 1: Estimation of Correlation Kernel

To analyze the correlation between signals to identify the point where significant changes occur in the underlying data generating process, we use the correlation kernel among the M locations (with β=0.5). The correlation matrix is self-normalizing, which makes it suitable for the DAS application considered with minimal pre-processing needed. Moreover, it is always positive semidefinite that ensures properties in the reproducing kernel Hilbert space (RKHS).

$${Kernel ( x , y )}_{i , j} = exp ( - β ( 1 - {corrcoef ( x , y )}_{i , j} ) )$$

$$where$$

$${corrcoef ( x , y )}_{i , j} = \frac{cov ( {x}_{i} , {y}_{j} )}{\sqrt{var ( {x}_{i} ) var ( {y}_{j} )}}$$

The sample covariance matrix and variance vectors can be estimated from T observations.

### Step 2: Projection to Low-Dimensional Space.

In the original input space, each location is represented by a T dimensional vector. The correlation kernel K=Kernel(x, y) implicitly defines a mapping φ: [symbol] ^{T}→F, where F is infinitely dimensional. Using the M×M kernel matrix K as intermediate tool, we can get a computable projection the kernel feature of test point φ(x) into the n-th principal component by

$$〈 {V}^{n} , ϕ ( x ) 〉 = {\sum }_{j = 1}^{M} {α}_{j}^{n} 〈 ϕ ( {x}_{j} ) , ϕ ( x ) 〉 = {\sum }_{j = 1}^{M} {α}_{j}^{n} K ( {x}_{j} , x )$$

where

$${α}_{j}^{n} = {U}_{j}^{n} / {Λ}_{n}$$

is the normalized eigenvector of K, KU=UA. This kernel-based feature extraction V∈ [symbol] ^{D×M} based on Kernel PCA is of dimensional D, which effectively considers the major similarity of signals from all the M locations. In the implementation, double centering kernel matrix is used, \tilde{K}=C_{M}KC_{M}, where

$${C}_{M} {=}^{Δ} {I}_{M} - \frac{1}{M} {1}_{M} {1}_{M}^{T} .$$

Each row of V needs also to be centered to have zero mean.

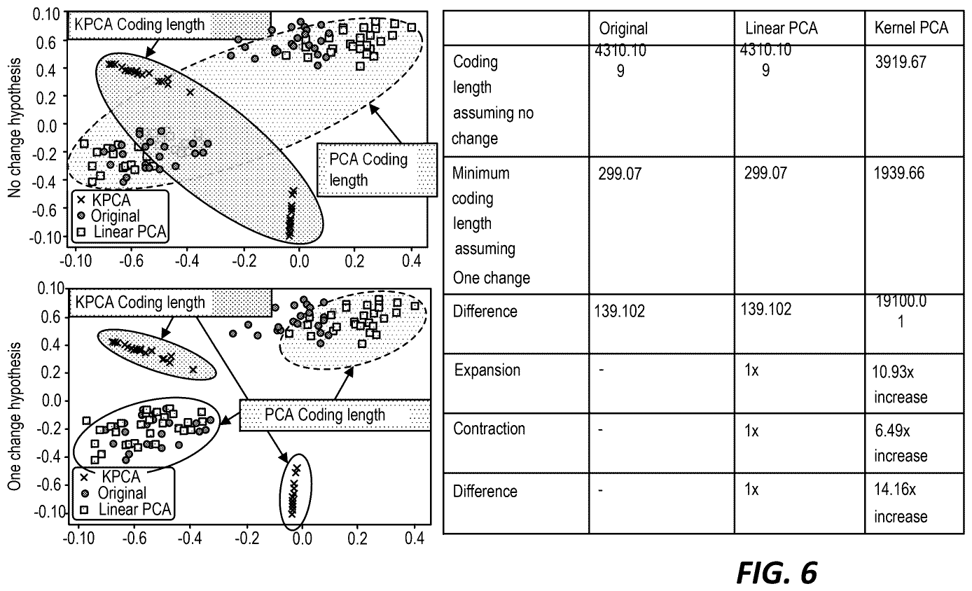

Note the difference with the T×T correlation matrix used in conventional principal component analysis (PCA) on standardized observations at each time t. The conventional choice only captures linear dependencies and the dimension of non-zero eigenvalues is limited to be less than T. On contrary, the kernel designed in below can capture arbitrary high-order nonlinear dependencies with upper limit of eigenvalues to be M, T<M. The extracted-feature can behave very differently and have a profound impact on the coding length, as is shown in FIG. 6, which shows illustrative expansion and contraction of kernel-extracted features space and impact on coding length under a “no change” hypothesis and “one change” hypothesis according to aspects of the present invention.

### Step 3: Change Detection by Minimizing Coding Length.

A lossy coding scheme maps a set of vectors to a sequence of binary bits such that the original vectors can be recovered up to an allowable coding distortion [symbol] [∥vⱼ−\tilde{v}ⱼ∥²]≤ε², the length of the encoded sequence is L(V): [symbol] ^{D×M}→ [symbol] ₊. Under the no-change hypothesis H₀ with Gaussian assumption, the overall coding length [3] needed to encode the dataset V is,

$$L ( V ) = \frac{M + D}{2} {log}_{2} det ( {I}_{D} + \frac{D}{{ε}^{2} M} V {V}^{T} )$$

F Under the hypothesizes Hₗ of “one change point happened at location l” with mixture of Gaussian assumption, the overall coding length needed to encode the partitioned datasets V₁=[v₁, . . . , vᵢ₋₁] and V₂=[vₗ, . . . , v_{M}] and the assignment membership is,

$${S}_{i} ( {V}_{i} ( l ) ) = \frac{{m}_{i} ( l ) + D}{2} {log}_{2} det ( {I}_{D} + \frac{D}{{ε}^{2} {m}_{i} ( l )} {V}_{i} {V}_{i}^{T} ) + {m}_{i} ( - {log}_{2} ( \frac{{m}_{i} ( l )}{M} ) ) ,$$

$$i = 1 , or 2$$

where m₁=l−1, and m₂=M−l+1, ε=0.000, D=100.

FIG. 6 shows illustrative expansion and contraction of kernel-extracted features space and impact on coding length under a “no change” hypothesis and “one change” hypothesis according to aspects of the present invention. Therefore, we arrive at the following rule for detection whether a rapid SOP alternation has occurred along the fiber route,

H₀: if L(V)≤min(S₁(V₁(l))+S(V₂(l))) and H₁: otherwise

Furthermore, we identify the change location l* from M candidate points across the entire routes by the following formula.

l*=argmin_{1≤l≤M}S₁(V₁(l))+S₂(V₂(l))

### Baseline Comparisons (Simulation Study):

The left panel of FIG. 6 shows a 2D kernel extracted features space by (1) T×T Linear kernel+Linear PCA, and (2) M×M Correlation kernel+Kernel PCA (effective dimension=2). As compared to the original 2D input space, linear PCA has no effect on expanding the volume of the feature space under “no change” hypothesis L(V), or contracting the volume of the feature space under the one-change hypothesis. In comparison, kernel PCA expands the volume L(V) under the no-change hypothesis by 8.93 times, and contract the volume under “one change” hypothesis S by 6.49 times. Overall, the sensitivity in difference L(V)−S is improved by 14.16 times. This demonstrate the advantages of our choices for the correlation kernel, kernel PCA feature extraction, and the effectiveness of the coding length as quantitative metric for change detection and localization.

### Change Detection Performance (Field Validation):

We now describe the change detection performance of rapid SOP alternation on 80 KM length cable route upon hand shaking of cable using coded-mode DAS. We studied two scenarios: (1) subtle change at 30 KM, (2) no change. We compare our method to a sliding-window based approach with running Z-score from the left, in detecting subtle changes

In our inventive approach, by comparing the one curve (coding length under one change assumption) with the dashed curve (coding length under no change assumption), a determination is made on whether a change occurred. (When the one curve is below black dashed curve, it indicates “change detected”)

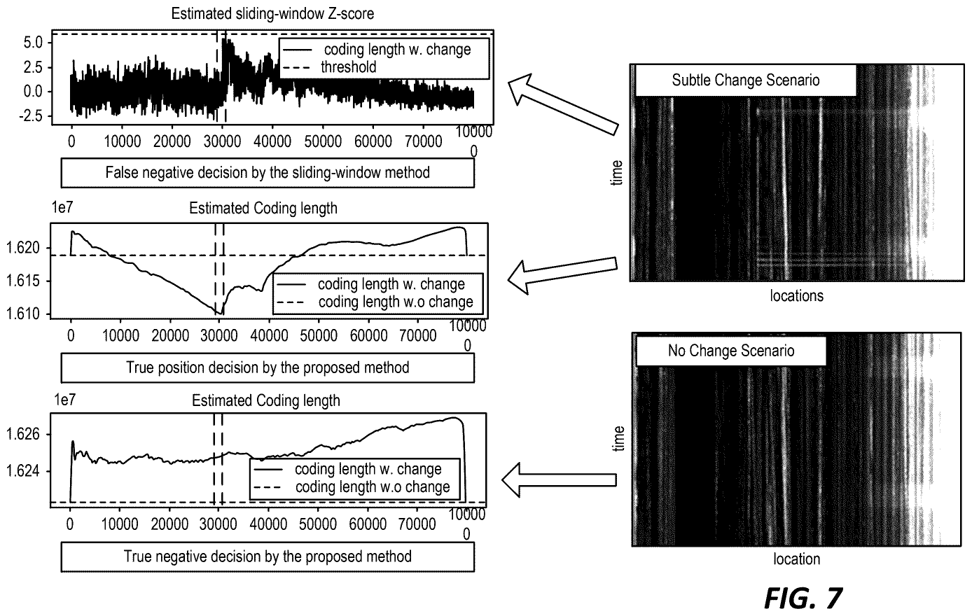

FIG. 7 shows change detection performance upon subtle change or no change for our inventive method by a sliding window-based baseline approach according to aspects of the present disclosure.

From FIG. 7, we can observe that sliding window-based approach missed the subtle change at 30 KM. The performance strongly depends on the threshold parameter (whether Z-score indicated by blue curves exceed the black dash threshold line). As a result, the localization as the “leftmost” changing point also depends on the threshold parameters. Unfortunately, this is no good guideline for the selection of this threshold parameter.

### Change Localization Performance (Field Validation):

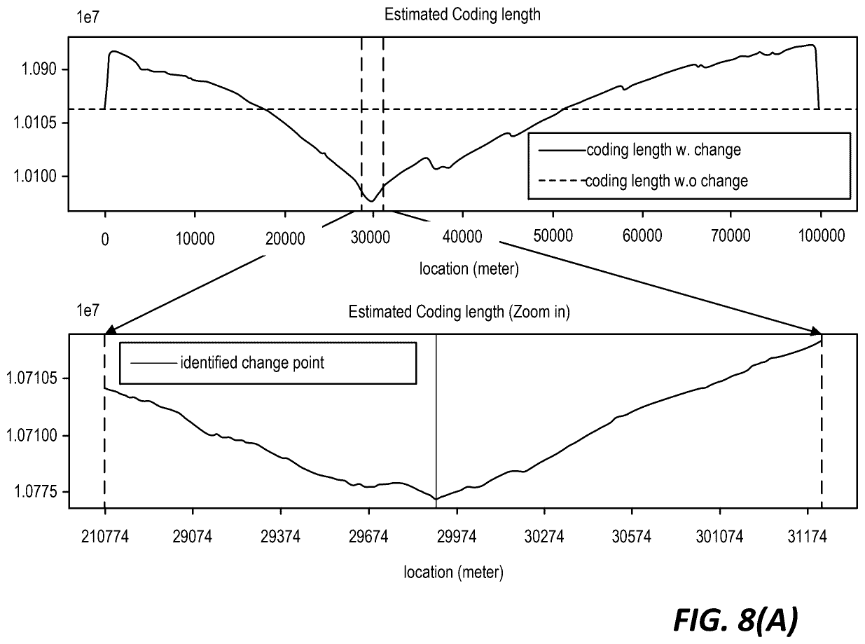

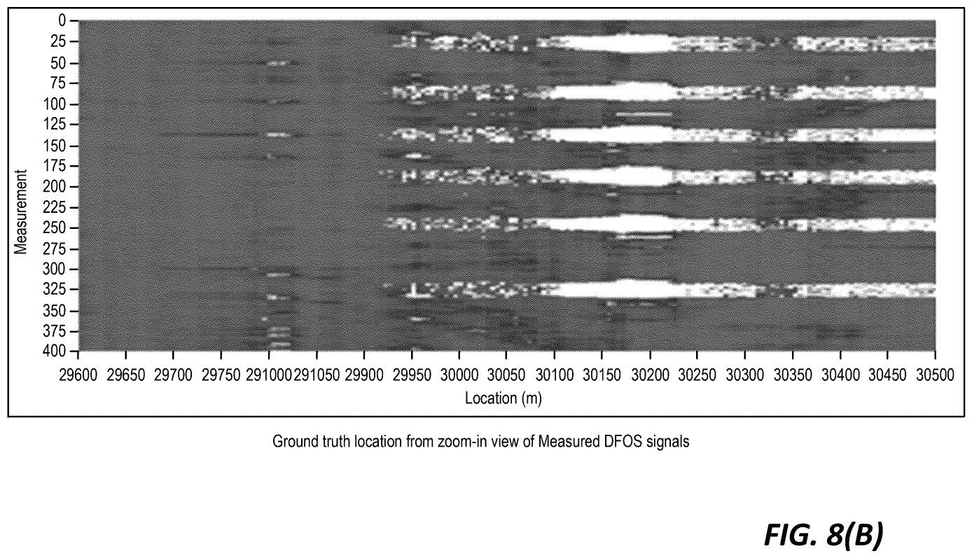

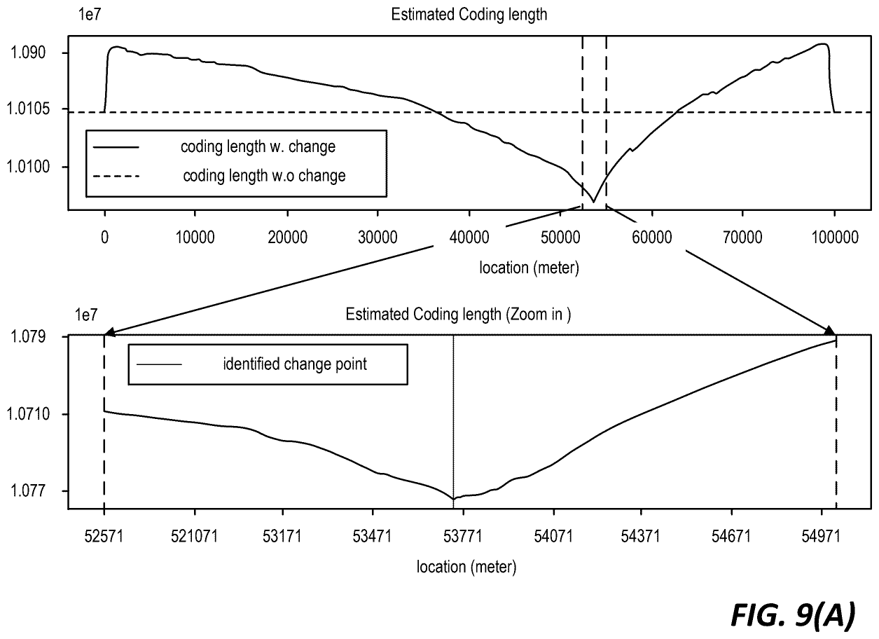

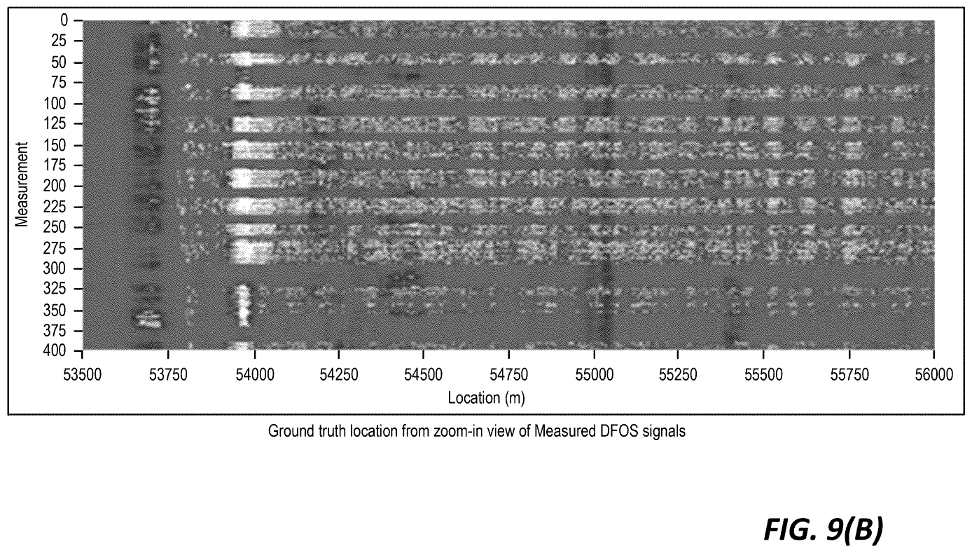

In this section, we further study the change localization performance of rapid SOP alternation on 80 KM length cable route upon hand shaking of cable using coded-mode DAS. We studied two scenarios: (1) change at around 30 KM (see, FIG. 8(A), and FIG. 8(B), in which FIG. 8(A) shows change localization with Zoom-in comparison at around 30 KM and FIG. 8(B) is a plot of ground truth location from zoom-in view of measured DFOS signals according to aspects of the present disclosure), (2) change at around 54 KM (see, FIG. 9(A), and FIG. 9(B), in which FIG. 9(A) shows change localization with Zoom-in comparison at around 54 KM and FIG. 9(B) is a plot of ground truth location from zoom-in view of measured DFOS signals according to aspects of the present disclosure.)

Despite different hand shaking patterns, our inventive method can successfully report the location with high accuracy, as evidenced in the zoom-in view and comparison to the snapshot of the sensor reading on the right.

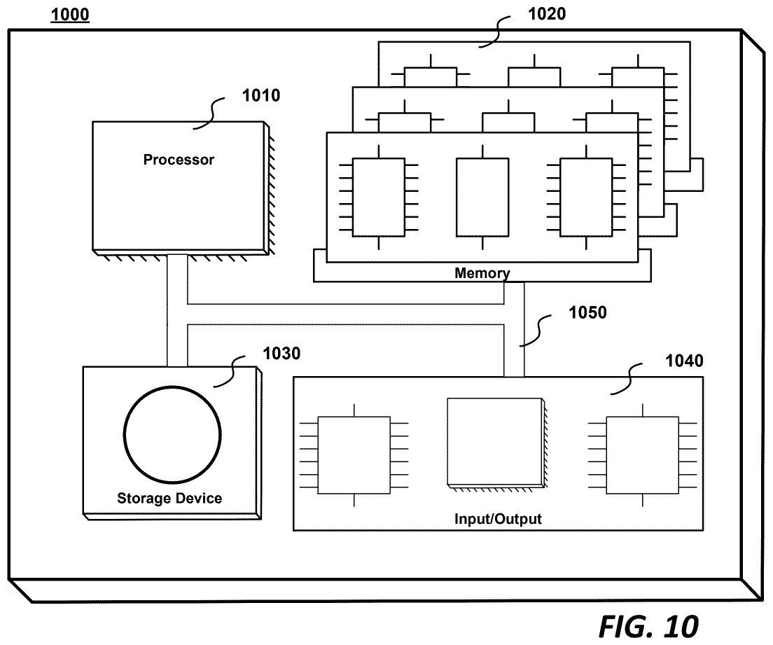

FIG. 10 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of a number of operating systems. The above-described methods of the present disclosure may be implemented on the computer system 1000 as stored program control instructions.

Computer system 1000 includes processor 1010, memory 1020, storage device 1030, and input/output structure 1040. One or more input/output devices may include a display 1045. One or more busses 1050 typically interconnect the components, 1010, 1020, 1030, and 1040. Processor 1010 may be a single or multi core. Additionally, the system may include accelerators etc., further comprising the system on a chip.

Processor 1010 executes instructions in which embodiments of the present disclosure may comprise steps described in one or more of the Drawing figures. Such instructions may be stored in memory 1020 or storage device 1030. Data and/or information may be received and output using one or more input/output devices.

Memory 1020 may store data and may be a computer-readable medium, such as volatile or non-volatile memory. Storage device 1030 may provide storage for system 1000 including for example, the previously described methods. In various aspects, storage device 1030 may be a flash memory device, a disk drive, an optical disk device, or a tape device employing magnetic, optical, or other recording technologies.

Input/output structures 1040 may provide input/output operations for system 1000.

At this point, those skilled in the art will understand and appreciate that we introduce a Deep Phase-Magnitude Network (DFMN) and point out that combining the filtering in time domain and frequency domain can significantly enhance the classification accuracy and improve the domain generalization ability. We divide the raw fiber sensing data into magnitude response and phase response for parallel feature representation learning. Furthermore, we propose a Phase Frequency Learnable Filter (PFLF) specifically designed for phase component learning, which effectively determines the frequency components crucial for enhancing rain detection accuracy. In the end, we formulate the phase-magnitude channel within a dual-path network and subsequently fuse the features for a comprehensive analysis. Extensive experiments and ablation studies demonstrate the effectiveness of our proposed method.

While we have presented our inventive concepts and description using specific examples, our invention is not so limited. Accordingly, the scope of our invention should be considered in view of the following claims.

1. A method for detecting and localizing state of polarization (SOP) disturbances occurring in coded-mode distributed acoustic sensing (DAS) system operation, the method comprising:
receiving distributed fiber optic sensing (DFOS)/distributed acoustic sensing (DAS) data as input;
using the received data, detecting and localizing a SOP disturbance;
wherein the detecting and localizing is based on a special spatial phenomenon observed in the coded-mode DAS.

2. The method of claim 1 further comprising generating a correlation kernel and analyzing correlation among M locations along an optical sensor fiber of the DFOS/DAS system.

3. The method of claim 2 further comprising projecting the M locations to a low-dimensional space.

4. The method of claim 3 further comprising determining an overall coding length L.

5. The method of claim 4 further comprising determining the overall coding length L and comparing L with a calculated minimum coding length S(k) and if L is greater than S(k), then outputting an indication of an occurrence of an SOP disturbance at location k.
